(19) United States
(12) Patent Application Publication
(10) Pub. No.: US 2007/0195031 A1
(43) Pub. Date: Aug. 23, 2007

(54) MULTI-CONFIGURATION DISPLAY DRIVER

(75) Inventors: Nick M. Miller IV, Rootstown, OH (US); Xiao-Yang Huang, Stow, OH (US)

Correspondence Address: PEARNE & GORDON LLP, 1801 EAST 9TH STREET, SUITE 1200, CLEVELAND, OH, 44114-3108, US

(73) Assignee: KENT DISPLAYS INCORPORATED, Kent, OH (US)

(21) Appl. No.: 11/680,799

(22) Filed: Mar. 1, 2007

Related U.S. Application Data
(63) Continuation-in-part of application No. 11/668,142, filed on Jan. 29, 2007, now abandoned.
(63) Continuation-in-part of application No. 10/782,461, filed on Feb. 19, 2004, now Pat. No. 7,190,337.
(60) Provisional application No. 60/484,337, filed on Jul. 2, 2003.

(51) Int. Cl. G09G 3/36

(52) U.S. Cl. 345/87

(57) ABSTRACT

Modular and configurable display drivers for driving a bistable liquid crystal display. The drivers have configurable outputs set by a plurality of configuration bits for driving rows or columns of various displays configurations. The configurable outputs of some of the drivers can be reconfigured during a display operation. Thus, the driver can be economically mass produced for use in many products.

### CROSS-REFERENCE TO RELATED APPLICATIONS

This application is a continuation-in-part of application Ser. No. 11/668,142 filed on Jan. 29, 2007, and a continuation-in-part of application Ser. No. 10/782,461 filed on Feb. 19, 2004, which claims the benefit of provisional application Ser. No. 60/484,337 filed on Jul. 2, 2003, all of which are incorporated herein by reference.

### FIELD OF THE INVENTION

This application relates generally to a display driver for a display device. More specifically, this application relates to a modular and configurable display driver for driving a bistable display, especially a cholesteric liquid crystal display (LCD).

### BACKGROUND OF THE INVENTION

Display driver availability is an important factor of the success of any display technology, especially in relation to the technology feasibility and the long term manufacturing cost. Modular and configurable display drivers that can be mass produced and used in a variety of applications could be cheaply made, making display technology more affordable in more products. In particular, low power LCDs using relatively cheap, configurable display drivers could be used in a variety of portable electronic devices.

Bistable displays that do not require continuous voltage application to maintain their state are becoming particularly important in low power applications. Various technologies can be utilized to provide bistable displays, including (but not limited to): Cholesteric Liquid Crystal Displays (ChLCD); Electrophoretic Displays; Bi-Stable STN Displays; Bi-Stable TN Displays; Zenithal Bi-Stable Displays; Bi-Stable Ferroelectric Displays (FLCD); Anti-Ferroelectric Displays; Interferometric Modulator Display (IMoD); and Gyricon (oil-filled cavity, beads are “bichromal,” and charged) displays.

In particular, bistable reflective cholesteric liquid crystal displays (ChLCDs) have been of great interest in the last several years because of their excellent optical properties and low power advantage. Two major drive schemes are known to be available at the time of this disclosure: (1) conventional drive and (2) dynamic drive. Typically, ChLCDs require drive voltages around 40V. High multiplex, off-the shelf (OTS) STN-LCD drivers can accommodate this requirement for a conventional drive. However off-the-shelf drivers for commercially offering dynamic drive ChLCDs would be beneficial.

Driver cost is an issue that is important to the commercial success of a display technology. Using high multiplex STN-LCD drivers benefits ChLCDs with conventional drive significantly in the sense of cost. Leveraging off of the high market volume and the mature technology of STN drivers enables ChLCDs to enjoy volume pricing. However, the practical use of passive matrix STN drivers is limited as a result of the physical response of STN-LCDs; the larger the format of the STN display, the higher the multiplex ratio and the higher the passive matrix driver voltage that is required.

In other words, the STN drive voltage requirements for a passive matrix driver are a direct function of the number of rows to be driven. As such, the 40V STN driver versions used by cholesteric displays are only designed for use in STN displays with formats larger than ¼ VGA (320 columns×240 rows). Because of this coupling of 40V drivers with large display formats, these 40V STN drivers have more than 80 outputs to minimize the assembly cost and display packaging.

In contrast, the drive voltage of ChLCDs is independent of display format. No matter how many rows are to be driven, the drive voltage is fixed as a function of the cell design and structure as opposed to the number of rows to be driven. This presents a problem for small ChLCD modules where many driver outputs are unused from an OTS (Off The Shelf) high multiplex STN driver. For example, a small Ch-LCD module, such as a 32 row by 128 column display requires a 160 output STN row driver and a 160 output STN column driver. In that case, 160 total driver outputs are wasted which increases the total required driver cost. This fact that 40V STN drivers are only available in format larger than 80 outputs can severely affect the market strength of ChLCDs in small formats.

Further, because ChLCDs can be scaled without impacting the required row driver voltages, economies of scalable technologies can be achieved for ChLCDs that may not be possible for STN-LCDs, thus further allowing display driver costs to be reduced.

Current ChLCD driver design efforts for a dedicated ChLCD driver enable consideration for optimization of the driver for the best interest of the technology. This proposed custom driver could be configured simultaneously as a column and row driver. Furthermore, this driver could accommodate both the dynamic and conventional drive schemes. New display drivers directed toward ChLCDs for covering a wide range of display formats providing advantage in high volume and maximum flexibility are thus desirable.

Examples of LCDs that could utilize a driver with one or more of the above benefits include the device disclosed by U.S. Patent Application number 2002/0030776 A1, published on Mar. 14, 2002, which discloses a backlit cholesteric liquid crystal display, and is hereby incorporated by reference in its entirety. U.S. Pat. No. 6,377,321, issued on Nov. 25, 2003, discloses a stacked color liquid crystal display device including a cell wall structure and a chiral nematic liquid crystal material, and is hereby incorporated by reference in its entirety. Further, U.S. Pat. No. 6,532,052, issued on Mar. 11, 2003, discloses a cholesteric liquid crystal display that includes a homogeneous alignment surface effective to provide increased brightness, and is hereby incorporated by reference in its entirety.

Furthermore, a configurable display driver that could be dynamically configurable would also be beneficial, in order to support a host of display applications and formats due to its flexibility of output configurations.

### SUMMARY OF THE INVENTION

Provided are a plurality of embodiments the invention, including, but not limited to:

A display driver comprising a plurality of display outputs each for outputting a drive voltage to a row or a column of a display. The driver also has a plurality of configuration bits each having a row/column setting. Each configuration bit is exclusively associated with one or more of the plurality of display outputs such that the row/column setting of the configuration bit is used to configure all of the associated one or more display outputs for driving either rows or columns of the display.

Also provided is a display driver comprising a plurality of driver blocks, with each of the plurality of driver blocks including a plurality of display outputs each for outputting a drive voltage to a row or column of a display. Each driver block also has a configuration bit having a row/column setting.

Each driver block is configured to drive either rows or columns of the display according to the configuration bit row/column setting, and each of the plurality of display outputs of the driver block is thereby configured to input the drive voltage to either a row or a column of the display, respectively.

Still further provided is a display driver for driving a display, with the display driver comprising a plurality of driver blocks, each driver block including a plurality of display outputs. The display outputs are each for outputting a voltage to a row or a column of a display. Each driver block has a configuration bit having a row/column setting.

All of the plurality of display outputs of the driver block are set to drive either rows or columns of the display according to the configuration bit setting. Further, each of the plurality of driver blocks can be set independently to drive either rows or columns.

Further provided is the above display driver further including a cascade input; and a cascade output.

Two or more of the plurality of driver blocks can be cascaded together for driving additional rows or columns of the display by connecting a cascade input of one of the two or more driver blocks to the cascade output of another of the two or more driver blocks.

Further provided is a display driver comprising: a plurality of display outputs each for outputting a drive voltage to a row or a column of a display; a configuration bit having a row/column setting; a cascade input; and a cascade output.

The row/column setting of the configuration bit is used to configure one or more display outputs for driving either a row or a column of the display. Further, a first display driver can be cascaded with a second display driver by connecting the cascade output of the first display driver with the display output of the second display driver for driving additional rows or columns of the display.

Additionally provided is a circuit for driving a display, said circuit comprising: at least one display driver. The driver includes a plurality of display outputs each configurable for outputting a drive voltage for driving a row or a column, and a plurality of configurable bits (configuration bits) each having a row/column setting for configuring an associated one or more of the display outputs for driving either a row or a column. The circuit further includes means for configuring each of said configurable bits to either a “row” or a “column” setting.

Also provided is circuit for driving a display, said circuit comprising at least one display driver. The display driver having a plurality of outputs including at least one display output configurable for outputting a drive voltage for driving one of a row and a column, and at least one other display output configurable for outputting a drive voltage for driving one of a row and a column independent of said at least one display output.

The display driver also including a plurality configurable bits each having a row/column setting, wherein at least one of said configurable bits is associated with said at least one display output for configuring said at least one display output for driving either a row or a column, and wherein at least another one of said configurable bits is associated with said at least one other display output for configuring said at least one other display output for driving either a row or a column.

The circuit also comprising a controller for configuring each of said configurable bits to either a “row” or a “column” setting, wherein said controller is adapted such that configurable bits can be reconfigured such that at least a subset of said plurality of outputs can be changed from outputting a drive voltage for driving one of a row and a column to driving the other of a row and a column.

Further provided is device comprising: a display and at least one display driver, said driver including a plurality of outputs connected to said display. The display outputs includes: at least one display output configurable for outputting a drive voltage for driving one of a row and a column, and at least one other display output configurable for outputting a drive voltage for driving one of a row and a column independent of said at least one display output.

The display driver also includes a plurality configurable bits each having a row/column setting, wherein at least one of said configurable bits is associated with said at least one display output for configuring said at least one display output for driving either a row or a column, and wherein at least another one of said configurable bits is associated with said at least one other display output for configuring said at least one other display output for driving either a row or a column.

The device also comprise a controller for configuring each of said configurable bits to either a “row” or a “column” setting, wherein said controller is adapted such that at least some of said configurable bits can be dynamically reconfigured during operation of said display such that at least a subset of said plurality of outputs can be changed from outputting a drive voltage for driving one of a row and a column to driving the other of a row and a column of said display.

In addition, provided is a method for driving a display having rows and columns, with the method comprising the steps of:
providing a plurality of outputs by at least one display driver, wherein each said display driver includes a subset of said plurality of outputs and is adapted such that some number of said subset of said outputs is configurable for driving rows while the remaining number of said subset of said outputs is concurrently configurable for driving columns; and
configuring some number of said plurality of outputs for driving the rows of the display and configuring some remaining number of said plurality of outputs for driving the columns of the display.

### BRIEF DESCRIPTION OF THE DRAWINGS

FIG. 1 is a schematic representation of an LCD driver driving both rows and columns of an LCD;

FIG. 2 is a schematic representation of a display driver comprised of individually configurable blocks;

FIG. 3 is a schematic representation of one of the individually configurable blocks of FIG. 2;

FIG. 4 is a schematic representation of the connections between two cascaded blocks of a display driver;

FIG. 5 is a schematic representation of one embodiment of a display driver having configurable blocks;

FIG. 6 is a schematic representation of another embodiment of a display driver having configurable blocks;

FIG. 7 is a schematic representation of an embodiment of a display driver having individually configurable outputs;

FIG. 8 is a more detailed schematic representation of the internal configuration of a display driver or a configurable block;

FIG. 9 is a schematic representation of the embodiment of FIG. 5 driving both the rows and columns of a display;

FIG. 10 is a schematic representation of an embodiment of a two display drivers having configurable blocks being cascaded together to drive rows of a display;

FIG. 11 shows a simplified block diagram of an example embodiment of a dynamically configurable display driver;

FIG. 12 is a diagram demonstrating, for the example embodiment of the dynamically configurable display driver, a typical configuration of ten columns and a single row;

FIG. 13 is a diagram demonstrating, for the example embodiment of the dynamically configurable display driver, the driving of only five pixels that changed;

FIG. 14a is a diagram demonstrating, for the example embodiment of the dynamically configurable display driver, an image where all of the rows (and all of the pixels within the rows) will have to be updated;

FIG. 14b is a diagram demonstrating, for the example embodiment of the dynamically configurable display driver, the dynamic configuration change in the display that enables the image to be changed by only updating a single row;

FIG. 15a is a diagram demonstrating, for the example embodiment of the dynamically configurable display driver, a display configuration where a single character can be updated using a partial update; and

FIG. 15b is a diagram demonstrating, for the example embodiment of the dynamically configurable display driver, a configuration where both digits can be updated at the same time.

### DETAILED DESCRIPTION OF EXAMPLE EMBODIMENTS

Multi-Configuration Driver Design

Disclosed herein is a driver that is configurable to function as a row and/or column driver simultaneously. This display driver will be able to operate as a row and/or column driver depending upon the configuration of the output. That is, each output or a group of outputs will have a configuration bit (such as a configurable input or memory setting, for example) representing the operation mode. Expanding upon this concept is a driver with outputs divided into multiple blocks where each block can be configured as row or column driver mode independently. Blocks and/or drivers can be cascaded to increase the number of rows and/or columns being driven.

An R/C lead logic setting, or a bit setting in memory or a register, or a bus input setting can be used to configure the driver or a block portion thereof to operate in a row or column configuration. When set to a row configuration the rows are scanned line by line and the digital row decoder logic is used to determine the voltage output. When set to a column configuration, the driver operates in a column mode by using the digital column decoder logic to determine the voltage output that is applied. That is, the decoder logic for each output of the driver has two modes of operation (row or column) depending upon the configuration setting.

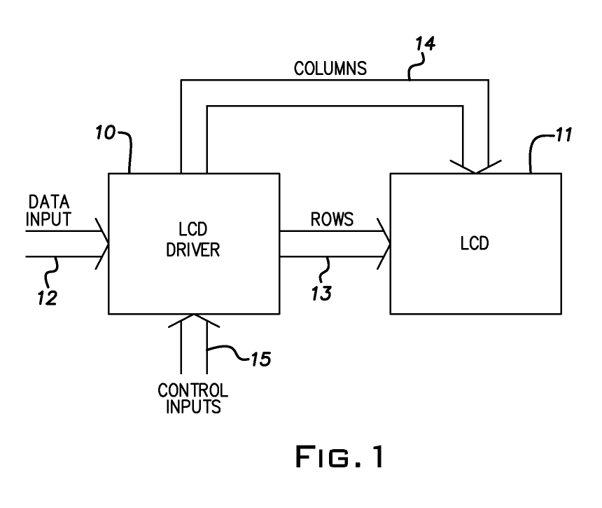

FIG. 1 shows a general schematic of the concept. The driver is contemplated for use with any display technology that can be driven by a driver of the type disclosed herein, especially displays of a bistable type. An LCD is used for illustration purposes as an example display application.

The driver 10 can be used to drive a display 11. The driver can output to rows 13, columns 14, or, as shown in FIG. 1, both rows 13 and columns 14. Data, power, and other inputs are input to the driver 10 via inputs 12. Control inputs 15 configure the driver 10 in the proper manner to drive rows, columns, or, as in this example, both.

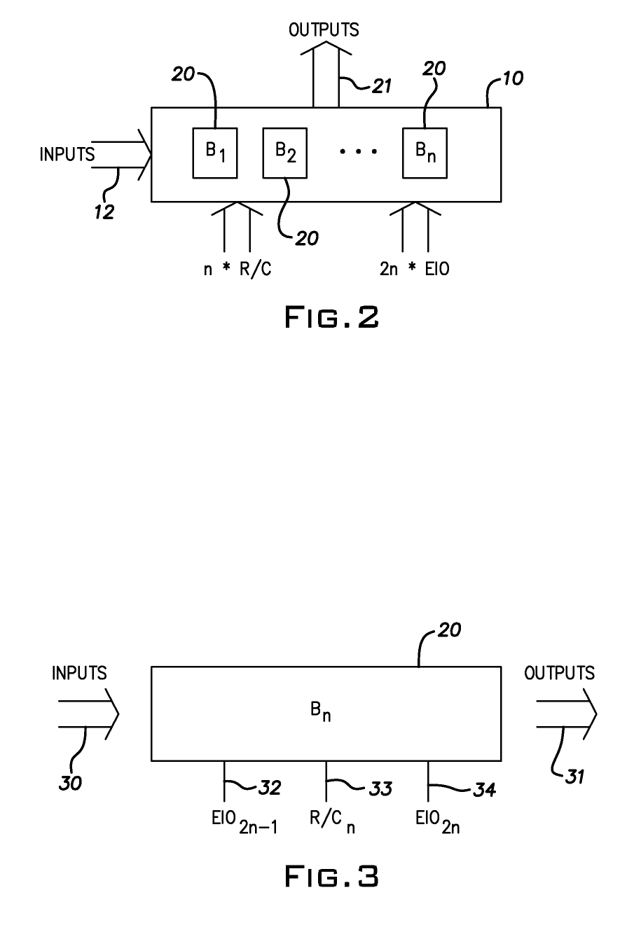

FIG. 2 shows an embodiment of the driver 10 made up of multiple blocks 20. Each block 20 acts as an individually configurable driver block, such that it can be set to drive either rows or columns. Blocks can be operated individually, or cascaded together to drive more display rows or columns than a single block can support, and thus the display outputs 21 can drive a flexible combination of rows and/or columns. Further, blocks from additional drivers can be cascaded together to support even more rows and/or columns. Because each block can be independently configured, the blocks can be arranged to support various displays of different arrangements. Power leads, and other test or monitoring inputs and/or outputs are not individually shown, but are included as part of the inputs 12, which can include Vdd, Vss, Vee, V1˜V8, LS, S0, S1, Disp_Off, SCLK, Dir, LP, and data inputs D1˜D8, for example. The number of potential columns/rows being supported is virtually unlimited, and can be organized in a complex and/or flexible manner.

FIG. 3 shows a block 20 in detail. Each block 20 has an R/C input 33 which configures the block to drive either a row or a column, depending on a voltage or logic value connected to the R/C input 33. Alternatively, row or column operation may be defined by setting a storage bit in a memory or register in the driver, or provided as a data code as part of the input data or from another data bus, in addition to other implementations. The key is that the block is configured such that its outputs are set to drive either columns or rows of a display, but not both at the same time. However, each block can be independently set, leading to great flexibility. And because there can be a plurality of blocks in each driver, the driver itself can flexibly drive a number of combinations of rows and/or columns.

The Enable Input/Output (EIO) input 32 and EIO output 34 for the block 20 are used for cascading blocks and/or drivers together to allow the display outputs 31 to be uniquely identified and defined, and thus to maintain the order of driving the rows or columns. The EIO input 32 is connected to an EIO output of a prior block/driver in cascade, if any, and the EIO output 34 is connected to the EIO input of the next block/driver in cascade, if any. Unused EIO inputs/outputs may be floating or preferably may be required to be set to some voltage/logic level, such as ground, for performance reasons. Each block will have a certain number of outputs 31 for driving either multiple rows or multiple columns of a display, as desired.

Referring to both FIGS. 2 and 3, if there are n blocks for a driver, there will be n R/C inputs, n EIO inputs, and n EIO outputs (for a total of 2n EIO leads) for configuring the blocks. The number of outputs may be fixed for all blocks, or some blocks may have more outputs than others. Typically, the data inputs 12 are common to all blocks, whereas each block has independent display outputs 31 that, in totality, make up the outputs 21 of the driver.

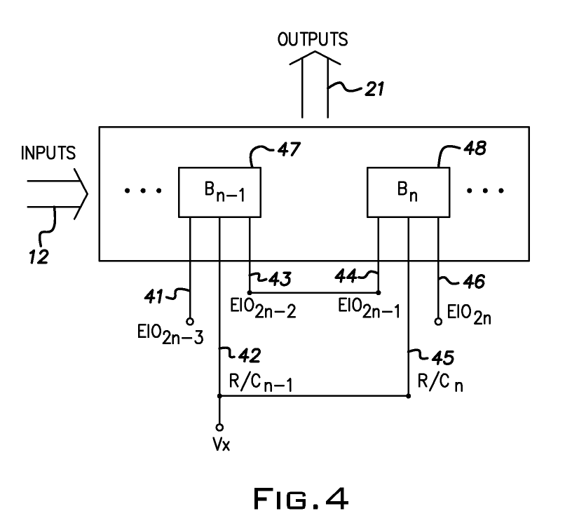

FIG. 4 shows an arrangement where two blocks 47, 48 in a driver are cascaded together. In this example, both block 47 and block 48 drive either rows or columns of a display. The R/C inputs 42 and 45 are thus connected to a common voltage (logic), defining either row or column operation, thus all outputs of the blocks drive either rows or columns (but not both at the same time). Note that the EIO output 43 of block 47 is connected to the EIO input 44 of block 48. In this manner, blocks 47 and 48 are cascaded together to drive a larger number of rows or columns than a single block could. In addition, the device can be made user configurable to provide a settable output voltage to support different LCDs devices.

Typically, the EIO and R/C connections are hardwired during construction of the driver apparatus using the driver for a particular display, although it would certainly be within the scope of the invention to make their configuration variable, such that a driver could be user or factory configurable, thus allowing multiple display formats to be utilized, such as for upgrading displays, for example. Further, such configurations could be set via software, hardware, etc. if desired.

The following three driver designs are offered as examples of preferred embodiments of this invention:

64-Output 100-Pin Quad Flat Pack (QFP)

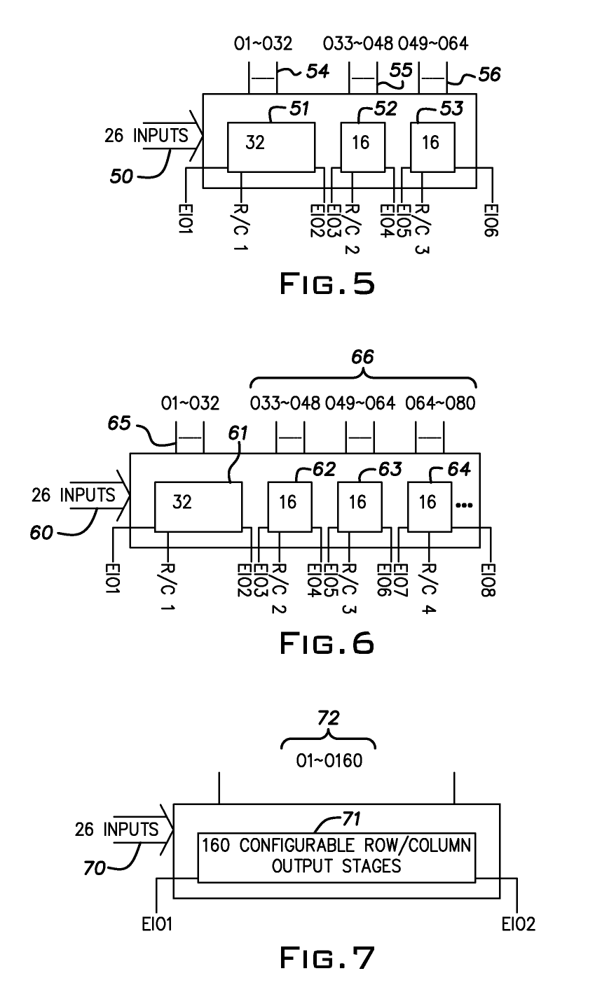

FIG. 5 shows an example embodiment with a reduced package format. This embodiment can be packaged as a 26-input, 64-output, 100 pin QFP package. The 64 outputs can be divided into one block 51 of 32 outputs display 54, and two blocks 52, 53 of 16 display outputs 55, 56. There are preferably 26 common inputs 50. The resulting total pin count is 99, which can utilize a 100 pin QPF.

This driver design can be configured so that the entire chip becomes a dedicated row or column driver by connecting EIO2 output to EIO3 input, EIO4 output to EIO5 input, and connecting R/C1, R/C2, and R/C3 together (and to a common logic voltage). Such an arrangement, by cascading multiple drivers in various arrangements, can be used to drive displays of at least the following formats:

64 row by 64 column;

64 row×128 column;

160 row×240 column;

240 row×320 column; and

480 row×640 column

By properly configuring the EIOs and R/Cs separately by block, the driver can also be configured to drive displays of at least the following formats:

16 row×48 column;

32 row×32 column; and

48 row×16 column.

By adding extra drivers in row or column mode, additional display formats can be supported, such as 16 row×112 column, and 32 row×96 column, for example. Additional configurations are possible through other arrangements.

In general, independent data shift direction logic (Dir) can be assigned to each block based on the optimal cost and application requirement.

80-Output 120-Pin QFP

As shown in the example of FIG. 6, the driver has 26 common inputs 60, as discussed for previous embodiments. The 80 display outputs 65, 66 are divided into 4 blocks, one of 32 outputs 65, and three of 16 outputs each 66.

For each of the 4 blocks, there is an independent set of R/C inputs and an EIO input and output lead. Depending on the logic (voltage) level of R/C pins (or bits), the block can be set in either the row or the column mode. Therefore, the device is a 118 pin driver which can be packaged in 120-pin QFP format. A Dir input can be added to each block to make the data shift direction independent among blocks. However, this will make the package be more than 120 total pins which would likely cost more.

The example embodiment shown in FIG. 6 can be configured with combinations for various display formats. This driver can be configured as an all row or all column driver by electrically connecting all R/Cs together and connecting EIO2 output to EIO3 input, EIO4 output to EIO5 input, and EIO6 output to EIO7 input. In this way, the driver can support large format displays such as ⅛ VGA (240 column×160 row), ¼ VGA (320 column×240 row) and VGA (640-column×480 row).

By configuring the EIOs and R/C's independently, a single driver can support 16 row×64 column, 32 row×48 column, 48 row×32 column, and 64 row×16 column. By adding another driver in the column mode, additional configurations include 16 row×144 column, 32 row×128 column, 48 row×112 column, etc. These are just a limited list of the possible combinations this driver can provide by configuring the blocks and/or additional drivers in various manners.

It will be noted that other embodiments can utilize different configurations of blocks, such as blocks with various numbers of output leads. Such configurations depend on the types of displays to be supported. It is believed that the embodiments of FIGS. 5 and 6 provide significant flexibility, allowing the driver to be utilized for various commonly used display configurations. However, the invention is not limited to these embodiments. Blocks of 2, 4, 8, or other combinations of leads can be utilized. Further, all blocks could utilize the same number of leads, or various combinations of numbers of leads, as needed for the desired application and/or for the desired flexibility.

160-Output Tape Carrier Package (TCP)

To provide maximum flexibility, a commercially available 160 output TCP package is also provided as an example, as shown in FIG. 7. For this embodiment, the configuration of blocks of outputs is replaced with individual configuration for each individual display output O1-O160 of the display outputs 72. Thus, each output is selectable to function in a row mode or in column mode. However, it is clear that a separate R/C lead for each output is not feasible for such large numbers of outputs. Nevertheless, the actual implementation can be performed in at least a few different ways, avoiding the need of using inputs 70 to set the output to row or column usage. For example, a data bus into the driver can be expanded to include a configuration data item or bit in addition to the voltage information to set the output configuration for each lead.

Alternatively, the driver could have a separate configuration register or memory where the output mode for each output could be stored. A single bit per lead could be used, for example. An advantage of this implementation is that the configuration information would not have to be repeatedly shifted into the device as long as power was maintained to this register memory portion. Using an EEPROM, or some other ROM type memory, could preserve the settings at a power loss.

With the driver design of FIG. 7, or some design utilizing some other number of driver outputs, the driver can be configured for any combination of rows and columns (160 pin package is chosen as an example because it is an accepted industry standard; other numbers of pins are easily accommodated in like fashion). As with the other examples, this driver could also function completely as a column or row driver for large format displays. Further, this driver can be cascaded using the EIO input/output leads, as described for the other embodiments above, allowing even greater flexibility to support a virtually unlimited number of output leads. Further, by combining combinations of the different embodiments, further flexibility could be provided.

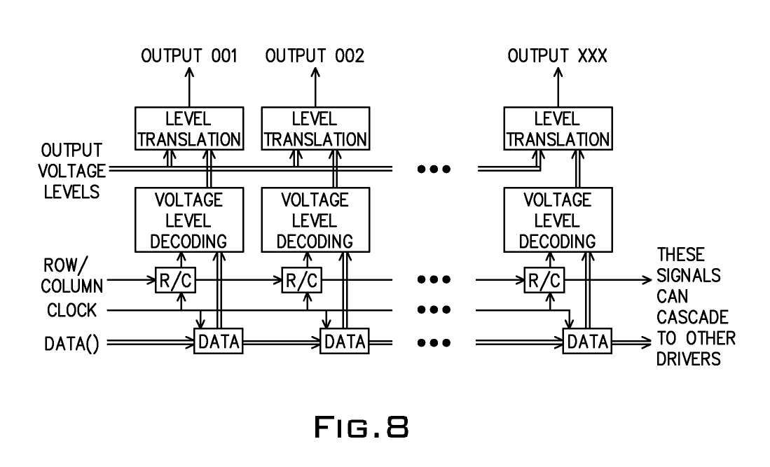

FIG. 8 provides a schematic of one possible implementation of circuitry for implementing the driver, provided as an example.

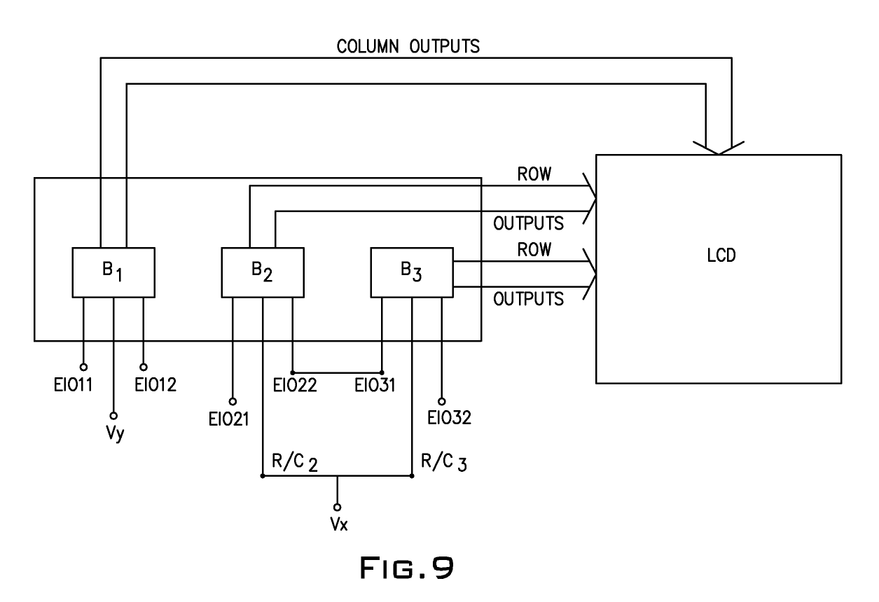

FIG. 9 shows one possible use of the embodiment of FIG. 5 to drive a display of 32 rows and 32 columns, showing an example of how the driver would be configured. V_{y} is the voltage/logic setting for column operation and Vₓ is the voltage/logic setting for row operation. Note that because blocks B₂ and B₃ are cascaded together to drive rows, the output EIO lead of B₂ is connected to the input EIO lead of B₃.

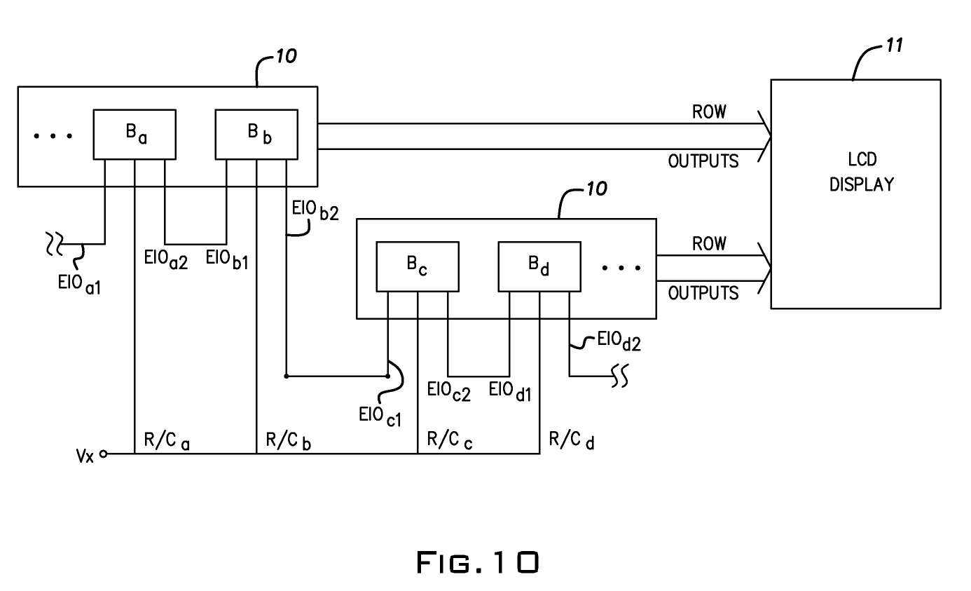

FIG. 10 is a further example of cascading blocks, where two drivers are cascaded together in order to drive a larger number of rows. In a similar manner, drivers and/or blocks can be cascaded to drive more rows, or to drive columns. Thus, the driver design provides great flexibility for supporting a large number of display configurations.

It will be understood that the above embodiments can be modified in various manners to obtain additional driver designs using different numbers of blocks, outputs, inputs, etc. The choice of design depends on the applications and the market conditions, or the desired packaging implementation. The overall concept is greatly flexible, as is shown by the examples.

As discussed above, a potential advantage of this multi-configurable driver is increased volume and flexibility. In addition, this invention allows one driver to support an entire product line of bistable display formats, which is not possible with current passive matrix STN-LCD drivers because their drive voltage changes with the display size. A driver design accommodating many display formats can significantly reduce the driver cost in the silicon fabrication, packaging, and supporting infrastructure.

In particular, this invention can be utilized for ChLCDs, and for any display technology that has a switching threshold voltage and is bi-stable. These are most easily supported because other common display technologies (such as STN and TN) have voltage requirements that are a function of the display multiplexing (multiplex ratio). For these technologies to overcome these voltage thresholds, the internal driver structure voltage must change as a function of the number of rows in the display. For bi-stable devices this is not the case; the voltage structure is independent of the number of rows in the display. Such a driver can also lend great support to emerging technologies by allowing them to compete with existing high volume technologies by utilizing one driver design to cover multiple display formats.

Thus, the current design can be most beneficially utilized in applications where the row drive voltage does not change dependent on the number of rows being driven. However, the design might also be utilized in other applications where maximum row/column driver flexibility is desired, including current STN-LCDs, by varying the row driving voltages in some manner, if necessary.

In particular, the driver is useful for driving bistable liquid crystal displays having chiral nematic liquid crystal material between substrates, wherein at least one of the substrates cooperates with an alignment surface and said liquid crystal material so as to form focal conic and planar textures that are stable in the absence of an electric field.

By tailoring the driver for use with various state-of-the-art displays, in particular bistable displays such as chiral nematic LCDs, for example, a flexible, versatile display device can be provided at reasonable costs.

For example, the display driver can be used to drive a liquid crystal display utilizing a stacked layer design disclosed in U.S. Pat. No. 6,377,321, incorporated herein in its entirety. That display is addressed by applying an electric field having a preferably square wave pulse of a desired width can be supported. The voltage that is used is preferably an AC voltage having a frequency that may range from about 125 Hz to about 2 kHz. Various pulse widths may be used, such as a pulse width ranging from about 6 ms to about 50 ms. The display may utilize the addressing techniques described in the U.S. Pat. No. 5,453,863 (incorporated herein by reference in its entirety) to effect grey scale.

An example of a single cell display is shown in U.S. Pat. No. 5,453,863, entitled Multistable Chiral Nematic Displays, which is incorporated herein by reference in its entirety. The spacing between the substrates of the single cell display may range from about 2 microns to about 10 microns.

The back substrate of each cell may be painted a particular color or a separate color imparting layer may be used. Examples of color imparting layers suitable for use in the present invention are provided in U.S. Pat. No. 5,493,430, entitled “Color, Reflective Liquid Crystal Displays,” which is incorporated herein by reference in its entirety. The back substrate of the visible cell that is furthest from the observer may be painted black or a separate black layer may be used to improve contrast, replacing layer.

Moreover, by utilizing grey scale by a process such as that disclosed in the U.S. Pat. No. 5,453,863, incorporated herein by reference, one or more cells of the display may be made to reflect light having any wavelength at various intensities. Thus, a full color display may be produced. The display may also be made to operate based upon principles of subtractive color mixing using a backlighting mode. The final color that is produced by various combinations of colors from each liquid crystal material, different colored backplates, and the use of grey scale, can be empirically determined through observation. The entire cell may be addressed, or the cell may be patterned with electrodes to form an array of pixels, as would be appreciated by those skilled in the art in view of this disclosure. The driver electronics for this display would be apparent to those skilled in the art in view of this disclosure.

Further, the driver can be utilized with backlit displays, such as is discussed in U.S. Pat. App. No. 2002/0030776, published on Mar. 14, 2002, incorporated herein by reference in its entirety. Such a chiral nematic liquid crystal display may be operated in both a reflective mode and a transmissive mode. The display includes a chiral nematic liquid crystal material located between first and second substrates, an ambidextrous or bidirectional circular polarizer, a partial mirror, also referred to as a transflector and a light source. A partial mirror or transflector reflects a portion of light incident on the partial mirror or transflector and transmits the remaining portion. The chiral nematic liquid crystal material includes focal conic and planar textures that are stable in the absence of an electric field. The ambidextrous circular polarizer is located adjacent to one of the substrates that bound the liquid crystal material.

An example of a stacked display that may be utilized by this invention is disclosed in U.S. patent applications Ser. No. 09/378,830, filed on Aug. 23, 1999 entitled “Brightness Enhancement for Bistable Cholesteric Displays” and Ser. No. 09/329,587, filed on Jun. 10, 1999 entitled “Stacked Color Display Liquid Crystal Display Device,” which are incorporated herein by reference in their entirety.

The driver can also be utilized with an LCD having enhanced brightness features, such as that discussed in U.S. Pat. No. 6,532,052, issued on Mar. 11, 2003, and incorporated herein by reference in its entirety.

Accordingly, a cost-effective, beneficial display device results by combining the configurable driver disclosed herein with the displays described in the references given above. Such a display can be utilized for a number of applications.

Some key concepts of some of the embodiments include one or more of:
A driver configurable for simultaneous row and column mode operation with outputs divided into more than one block;
A driver configurable for simultaneous row and column mode operation with outputs individually configurable;
Each output block can be configured independently for column/row mode and data shift direction;
The driver can cost-effectively drive a display with a small number of rows at a high drive voltage of more than 25V;
This multiple configuration driver concept can be also applied to other display drivers in consideration of cost reduction;
This concept can be used for drivers with any package format, such as QFP package, TCP package, chip-on-board, chip-on-flex, and chip-on-glass; and
Utilizing this driver to drive various state-of-the-art displays to create a display device.
   Dynamically Configurable Display Driver

The various embodiments provided above, and variations thereof, describe a display driver whose outputs can perform in both a row and column mode according to a desired system configuration. This could provide a substantial advantage in system cost and inventory. The configurability of the proposed devices enable a single design to cover a host of display applications and formats due to its flexibility of output configuration. However, any of the above embodiments, and many variations thereof, might be further modified to provide the capability of dynamically configuring the display driver to provide flexibility and improved performance during the operation of the display.

The concept of the configurable display driving device (driver) can be extended to provide additional benefits and advantages during display updating by providing dynamic configuration of the driver outputs. The configuration of the display driver can be changed not only during initial device configuration during application (for fixed use, for example), but the configuration can be updated dynamically during use, such as by changing the R/C bit settings during operation of the display. This brings several potential advantages to the display system, including one or more of:
1. Potential reduction of power usage;
2. Ability to change scan appearance/image presentation; and
3. Portions of the display that do need to be changed can maintain static (zero field). The importance here is that a viewer will not see a visual impact (e.g., flicker, scan lines, etc.) in the area of the display that does not need changed. In a multiplexed design, rows that are not selected can demonstrate a “dimming” effect as the voltage is applied to other areas of the display (columns).

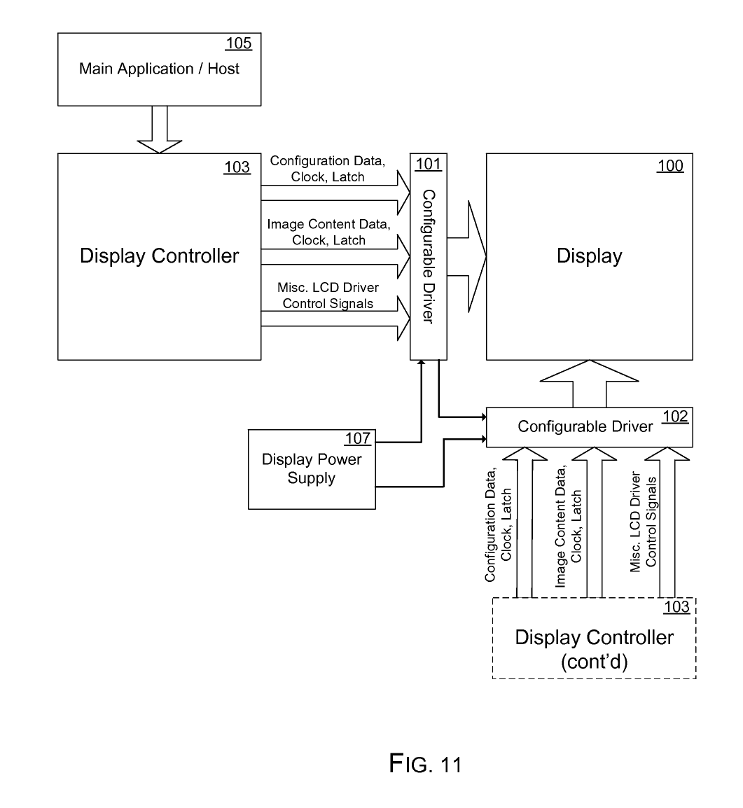

There are many possible implementations of a dynamically configurable driver system using a configurable driver, such as those described above. FIG. 11 shows a block diagram of an example embodiment of a dynamically configurable driver, where the display 100 has, for example, two configurable driver ICs 101, 102. These configurable driver ICs 101, 102 can be, for example, any of the configurable driver arrangements as described above in this application, or modifications thereof. Clearly, the number of such ICs actually utilized will depend on the particular application that they are to be used for. Two are shown in the figure for illustrative purposes, only.

The display controller 103 configures the driver outputs according to image content and system instruction. The host system 105 sends image content and display preference information (e.g., landscape or portrait mode) to the display controller 103. A display power supply 107 is also provided. The block diagram functionality can be consolidated in one device, for example.

In a ChLCD, which can be used for the display 100, the drive voltage is not a function of the number of rows (multiplex ratio), and thus the power supply voltages can remain constant regardless of the configuration.

The operation of the system of FIG. 11 is detailed as follows:
1. The main system application/host 105 sends new image data to the display controller 103;
2. The display controller 103 interprets the data and system display settings to determine the optimal row/column configuration; On the simplest order this criteria could be to configure the display driver so that the update can be accomplished by updating the minimum number of rows, for example.
3. If any change from the existing configuration is desired, the display controller 103 clocks in the new configuration data (e.g., sets the R/C bit settings) and latches the data to set each driver output to row or column mode (by dynamically setting the configuration bits that are discussed in the driver implementation examples provided hereinabove); and
4. The display controller 103 then updates the display (e.g., clocks in image data for each row, latches the data . . . standard display update, etc., for example as discussed in one or more referenced applications).

The configuration bit setting pins can be, for example: Configuration Data, Configuration Data Latch and Configuration Data Clock. For example, three pins can be used to accomplish this configuration. The FIG. 11 labels are abbreviated as Config. Data Clock and Latch. For example, there can be three lines represented by the arrow in FIG. 11 (or if a data bus is used, the function is to clock in configuration data—which may be parallel instead of serial—and latch it).

### DYNAMICALLY CONFIGURABLE DISPLAY DRIVER OPERATION EXAMPLES:

The concept of changing the display driver dynamically during the update or according to the data content can be demonstrated by the following examples:

### Example 1

Consider a display configuration of a single row (direct drive). In this example there is traditionally a single backplane (row) and multiple segments (columns). This could be an entire display or a section of a display. For a simplified example, consider the case of ten segments as shown in FIG. 12. Here is a direct drive display (segmented), or a portion of a display, where the driver is first configured as shown in FIG. 12 where there are ten columns and one row output. The display is then updated by driving the ten pixels with alternating on/off data to create the checkered image shown. For the sake of simplicity, the traditional AC balancing of the drive waveforms is ignored and it is assumed (for a typical ChLCD) that a net row-to-column voltage difference of 35V will turn a pixel bright (planar), a net row-to-column difference of 15V will turn a pixel dark (focal conic), and a net row-to-column difference of 0V will not change the pixel state. FIG. 12 demonstrates a configuration of ten columns and a single row (direct drive). A driven pattern is demonstrated where every other pixel is turned ON.

Consider next the case where it is desired to change the display so that all of the pixels are bright (planar). Traditionally, this would require the entire row to be updated even though only five pixels must actually change states. This not only causes the entire display to flicker (the display typically demonstrates a visual effect when voltage is applied) but used unnecessary power.

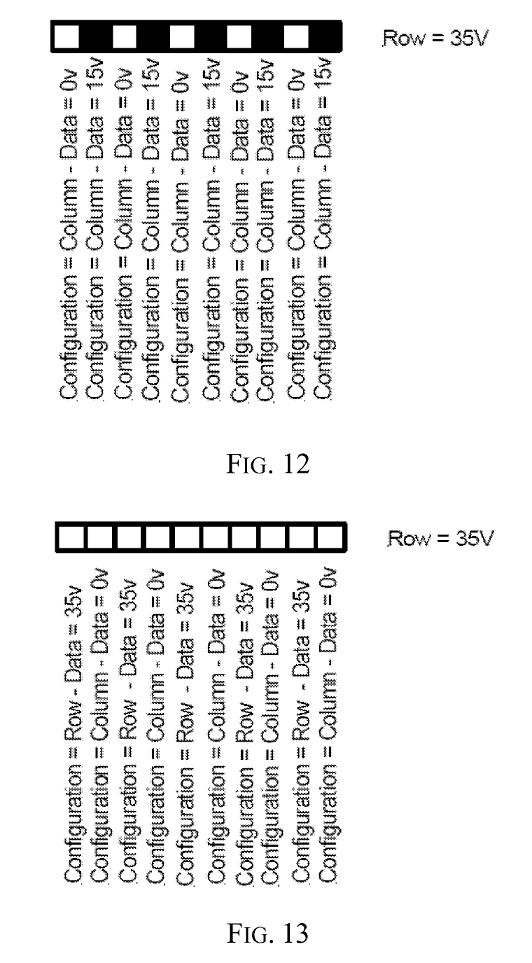

However, using the concept of this invention (i.e., dynamic reconfiguration), the driver IC could be re-configured so that only the pixels that require modification will experience a net difference in voltage. This is shown in FIG. 13, demonstrating the driving of only the five pixels that are to change.

To execute this process, the unchanged pixels are configured to be in row mode so that they have a net field of zero volts (35V on both electrodes), as shown in FIG. 13 where only the five pixels that where dark in FIG. 12 are now driven bright. Thus, the pixels that do not change are configured to row mode operation so that they do not experience any net field. This example demonstrates the concept of providing portions of the display with zero net driving field by dynamically configuring the driver output between row and column mode operation.

### Example 2

A second example demonstrating the dynamic configuration of the driver output modes is the switching of the display outputs between row and column modes as a function of display content and update presentation. Typically, the display is fixed in a particular format. For example, consider a 320×80 display which is typically configured as 320 columns and 80 rows.

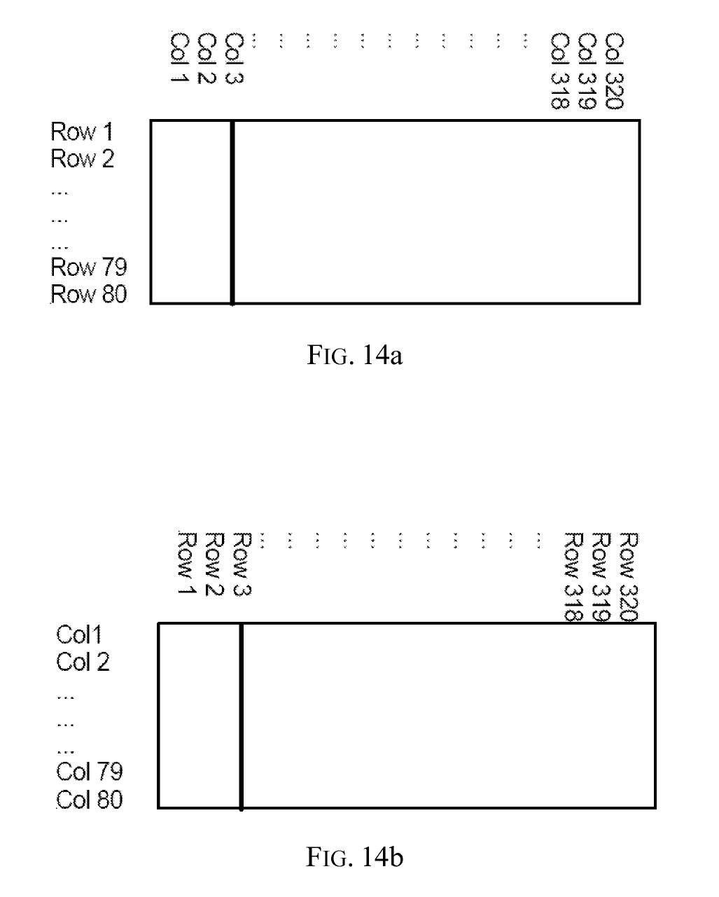

FIG. 14a demonstrates an image where all of the rows (and all of the pixels within the rows) will have to be updated with a refresh (i.e., the typical refresh approach). FIG. 14b, in contrast (by applying the inventive method), demonstrates the dynamic configuration change in the display that enables the image to be changed by only updating a single row.

Although by using a bi-stable ChLCD one need only update the rows that actually change (the others remaining in a current state), it is typically necessary in actual practice to update the entire row (320 columns wide) even if only a single pixel is to be changed within the row due to the passive matrix structure typically used. Consider the display shown in FIG. 14a being updated with only a single vertical line, but requiring all of the display to be updated using conventional techniques, in contrast applying the method, as in FIG. 14b, where only a single “row” (previously a column), need be updated.

This example demonstrates the invention's use of dynamic configuration, shown in FIG. 14b, where the display driver outputs could be modified to reverse the row and column operation. This results in the ability to perform the requested image update by only updating the single row (column 3 becomes row 3 for the update). This can result in significant power and time savings.

Although the examples in FIG. 14b demonstrates the time and power savings of using such a smart dynamic configuration capability, the driver configuration could also be modified to give a more pleasing update scan or image presentation. This simple change in scan direction could result from a user request, for example, to modify the display orientation (e.g., switching between landscape viewing and portrait viewing mode). For display technologies that typically would display a visible scan line during image updating, the ability to modify the scan orientation according to image content or user preference can provide a considerable product performance enhancement and improved features.

### Example 3

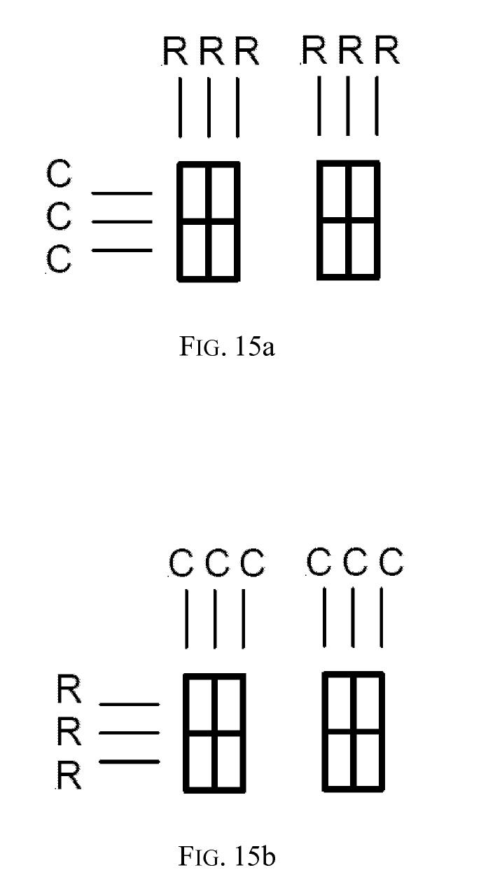

FIG. 15a demonstrates a display configuration where a single character can be updated using a partial update. FIG. 15b demonstrates a configuration where both digits can be updated at the same time.

Consider the display configuration of multiplexed segments as shown in FIGS. 15a,b. There, the display has two characters each comprised of 9-segments. Each character in this example is addressed with six electrodes (three column electrodes and three row electrodes). As shown in FIGS. 15a and 15b, respectively, the dynamic configuration of the driver IC enables the display to update both characters at the same time (FIG. 15a) or update one character (FIG. 15b). Updating both characters at one time provides a speed advantage when both characters are changing. However, this is a disadvantage if only one character needs to be modified. The ability to change between driver configurations enables the display to achieve faster updates and not scan characters that are not changing. This is an important feature for some devices, such as, for example, watches operating in time-of-day mode where the hour and minute digits need not be updated every second (only the digit that is changing need be updated).

The example shown in FIGS. 15a, 15b demonstrates how the dynamic configuration of the display driver can enable operating the display in a most advantageous way to optimize power consumption and update appearance.

In this example, if both characters (digits) are to be modified, the configuration in FIG. 15b would be the preferred choice to minimize the update time (image scan and power consumption). In contrast, if only one character is to be changed, the configuration shown in FIG. 15a might be preferred so that only one character will scan.

Clearly, the above examples represent simplifications of many other potential applications using a dynamic display driver, for example for driving much more complicated displays having more rows and/or more columns. In such applications, many driver ICs may be utilized together in a manner described above. However, the techniques disclosed for making the example applications dynamically configurable can be scaled up for such more complex uses using the techniques described in this section.

The invention has been described hereinabove using specific examples; however, it will be understood by those skilled in the art that various alternatives may be used and equivalents may be substituted for elements or steps described herein, without deviating from the scope of the invention. Modifications may be made to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

What is claimed is:

1. A circuit for driving a display, said circuit comprising:
at least one display driver, each said driver including:
a plurality of display outputs each configurable for outputting a drive voltage for driving a row or a column, and
a plurality of configurable bits each having a row/column setting for configuring an associated one or more of the display outputs for driving either a row or a column;
and
means for configuring each of said configurable bits to either a “row” or a “column” setting.

2. The circuit of claim 1, wherein said means for configuring is adapted for reconfiguring one or more of said configurable bits dynamically during an operation of the display.

3. The circuit of claim 1, wherein said means for configuring is adapted for reconfiguring one or more of said configurable bits dynamically in response to an input from a user.

4. The circuit of claim 1, wherein said means for configuring is adapted for reconfiguring one or more of said configurable bits dynamically in response to the content of an image to be displayed on the display.

5. The circuit of claim 1, wherein said means for configuring is adapted for reconfiguring one or more of said configurable bits dynamically in response to an analysis of the content of an updated image to be displayed on the display and also based on an analysis of a current image displayed on the display, wherein said analysis utilizes information about pixels of the display that are to change state when updated from the current image to the updated image.

6. The circuit of claim 1, wherein said means for configuring is adapted for reconfiguring one or more of said configurable bits by changing a plurality of said outputs from one or both of row settings to column settings and column settings to row settings during an update of an image being displayed on the display.

7. The circuit of claim 1, wherein said means for configuring is adapted for configuring one or more of said configurable bits only during an initial setup operation.

8. The circuit of claim 1, wherein, when at least one display output is set to drive a row of the display, said drive voltage output by said at least one display output is set independent of the total number of rows in the display.

9. The circuit of claim 1, wherein the display is a bistable display and wherein said display driver is adapted to drive the bistable display.

10. The circuit of claim 9, wherein the bistable display includes a chiral nematic liquid crystal material having a planar texture and a focal conic texture that are stable in the absence of an electric field.

11. The circuit of claim 1, wherein each display output is uniquely associated with one of the configuration bits.

12. The circuit of claim 1, wherein said means for configuring is a controller.

13. The circuit of claim 1, wherein said circuit includes a data bus and wherein said configurable bits are implemented utilizing said data bus and further wherein said means for configuring is connected to said data bus.

14. The circuit of claim 13, wherein said row/column settings are stored in at least one register in said driver.

15. The circuit of claim 14, wherein said means for configuring is a controller, and wherein said controller is adapted for reconfiguring one or more of said configurable bits dynamically during an operation of the display.

16. The circuit of claim 14, wherein each of said bits is associated with an input to said driver, such that a voltage on each of said inputs sets the setting of the associated bit.

17. A circuit for driving a display, said circuit comprising:
at least one display driver, said driver including a plurality of outputs including:
at least one display output configurable for outputting a drive voltage for driving one of a row and a column, and
at least one other display output configurable for outputting a drive voltage for driving one of a row and a column independent of said at least one display output,
said display driver also including a plurality configurable bits each having a row/column setting, wherein at least one of said configurable bits is associated with said at least one display output for configuring said at least one display output for driving either a row or a column, and wherein at least another one of said configurable bits is associated with said at least one other display output for configuring said at least one other display output for driving either a row or a column;
and
a controller for configuring each of said configurable bits to either a “row” or a “column” setting, wherein
said controller is adapted such that said configurable bits can be reconfigured such that at least a subset of said plurality of outputs can be changed from outputting a drive voltage for driving one of a row and a column to driving the other of a row and a column.

18. The circuit of claim 17, wherein said controller is adapted for reconfiguring one or more of said configurable bits dynamically during an operation of the display.

19. The circuit of claim 17, wherein said controller is adapted for reconfiguring one or more of said configurable bits dynamically in response to an input from a user.

20. The circuit of claim 17, wherein said controller is adapted for reconfiguring one or more of said configurable bits dynamically in response to the content of an image to be displayed on the display.

21. The circuit of claim 17, wherein said controller is adapted for reconfiguring one or more of said configurable bits dynamically in response to an analysis of the content of an updated image to be displayed on the display and also based on an analysis of a current image displayed on the display, wherein said analysis utilizes information about pixels of the display that are to change state when updated from the current image to the updated image.

22. The circuit of claim 17, wherein said controller is adapted for reconfiguring one or more of said configurable bits by changing a plurality of said outputs from one or both of row settings to column settings and column settings to row settings during an update of an image being displayed on the display.

23. The circuit of claim 17, wherein said controller is adapted for configuring one or more of said configurable bits only during an initial setup operation.

24. The circuit of claim 17, wherein, when at least one display output is set to drive a row of the display, the drive voltage output by said at least one display output is set independent of the total number of rows in the display.

25. The circuit of claim 17, wherein the display is a bistable display and wherein said display driver is adapted to drive the bistable display.

26. The circuit of claim 25, wherein the bistable display includes a chiral nematic liquid crystal material having a planar texture and a focal conic texture that are stable in the absence of an electric field.

27. The circuit of claim 17, wherein each of said bits is associated with an input to said driver, such that a voltage on each of said inputs sets the setting of the associated bit.

28. A device comprising:
a display;
at least one display driver, said driver including a plurality of outputs connected to said display, said display outputs including:
at least one display output configurable for outputting a drive voltage for driving one of a row and a column, and
at least one other display output configurable for outputting a drive voltage for driving one of a row and a column independent of said at least one display output,
said display driver also including a plurality configurable bits each having a row/column setting, wherein at least one of said configurable bits is associated with said at least one display output for configuring said at least one display output for driving either a row or a column, and wherein at least another one of said configurable bits is associated with said at least one other display output for configuring said at least one other display output for driving either a row or a column;
and
a controller for configuring each of said configurable bits to either a “row” or a “column” setting, wherein
said controller is adapted such that at least some of said configurable bits can be dynamically reconfigured during operation of said display such that at least a subset of said plurality of outputs can be changed from outputting a drive voltage for driving one of a row and a column to driving the other of a row and a column of said display.

29. A method for driving a display having rows and columns, said method comprising the steps of:
providing a plurality of outputs by at least one display driver, wherein each said display driver includes a subset of said plurality of outputs and is adapted such that some number of said subset of said outputs is configurable for driving rows while the remaining number of said subset of said outputs is concurrently configurable for driving columns; and
configuring some number of said plurality of outputs for driving the rows of the display and configuring some remaining number of said plurality of outputs for driving the columns of the display.

30. The method of claim 29, further comprising the step of, during an operation of the display, dynamically reconfiguring some of said plurality of outputs from driving one of the columns of the display and the rows of the display to driving the other of the columns of the display and the rows of the display.

31. The method of claim 30, further comprising the step of receiving an input from a user, and wherein said reconfiguring is in response to the input from the user.

32. The method of claim 30, wherein said reconfiguring is in response to the content of an image to be displayed on the display.

33. The method of claim 30, wherein said reconfiguring is done dynamically in response to an analysis of the content of an updated image to be displayed on the display and also based on an analysis of a current image displayed on the display, wherein said analysis utilizes information about pixels of the display that are to change state when updated from the current image to the updated image.

34. The method of claim 29, wherein said configuring is during an initial setup operation.
